(19) United States
(12) Patent Application Publication
(10) Pub. No.: US 2009/0318080 A1
(43) Pub. Date: Dec. 24, 2009

(54) Communication Apparatus, Communication Method, Communication System, and Computer Program

(76) Inventor: Yutaka TAKAGI, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/489,732

(22) Filed: Jun. 23, 2009

(30) Foreign Application Priority Data
Jun. 24, 2008 (JP) 2008-164508

(51) Int. Cl. H04B 5/00

(52) U.S. Cl. 455/41.1

(57) ABSTRACT

There is provided a communication apparatus including a communication unit for performing communication through electric field coupling or magnetic field coupling with other communication apparatus, at least one magnet arranged near the communication unit, and a magnetic control unit for controlling a polarity and a magnetic force of the magnet depending on a change in a communication status of the communication unit.

### BACKGROUND OF THE INVENTION

1. Field of the Invention

The present invention relates to a communication apparatus, a communication method, a communication system, and a computer program.

2. Description of the Related Art

In recent years, there has been broadly used a radio wave communication system specified in the IEEE (Institute of Electrical and Electronic Engineers) 802.11 has been widely used. The above radio wave communication system is configured such that an antenna is used to transmit and receive a wireless radio wave, but the wireless radio wave interferes with a radio wave transmitted or received therearound, which may affect the communication itself.

Other than the radio wave communication system, a communication system which uses electric field coupling or magnetic field coupling to perform communication is also proposed. In the communication system, for example, when a plurality of couplers for performing magnetic field coupling approach each other, the couplers magnetically couple so that communication is achieved between the couplers through magnetic field coupling. In this manner, according to the communication system utilizing electric field coupling or magnetic field coupling, since a signal is not transmitted when another communication party does not approach, It is difficult for interference to occur, and thus more advantageous than a radio wave communication system. A technique for performing communication through magnetic field coupling is for example described in Japanese Patent Application Laid-Open No. 2006-60283, or Japanese Patent Application Laid-Open No. 2008-99236.

Furthermore, in the communication system utilizing electric field coupling or magnetic field coupling, a plurality of functions, such as a reception function and a transmission function can be implemented on one communication apparatus. In this case, the communication apparatus may be both transmission side and reception side for content data.

### SUMMARY OF THE INVENTION

When a communication system utilizing electric field coupling or magnetic field coupling is used, communication may be performed between communication apparatus, one communication apparatus being stationary and the other being held in hand, by holding the hand-held communication apparatus over the stationary communication apparatus. Such a state is often seen when using an automatic ticket gate in a station, when purchasing a product at an automatic vending machine, or when paying cash at a register.

However, in many cases in related art, a ringing sound notifies a user of the completion of a communication, and a method for notifying a user of the completion of the communication through a change in a behavior of a hand-held communication apparatus has not been employed so far.

The present invention has been made in view of the above issue, and thus seeks to provide a novel and improved communication apparatus, communication method, communication system and computer program capable of grasping a change in a communication status through electric field coupling or magnetic field coupling from a magnetic behavior by utilizing a polarity of a magnet.

According to an embodiment of the present invention, there is provided a communication apparatus including: a communication unit for performing communication through electric field coupling or magnetic field coupling with other communication apparatus; at least one magnet arranged near the communication unit; and a magnetic control unit for controlling the polarity and magnetic force of the magnet depending on a communication status between the communication unit and the other communication apparatus.

With the above configuration, the communication unit performs communication with other communication apparatus through electric field coupling or magnetic field coupling, and the above magnet is arranged at least near the communication unit. The magnetic control unit controls the polarity and the magnetic force of the magnet according to the communication status between the communication unit and the other communication apparatus. Consequently, the change in the communication status through electric field coupling or magnetic field coupling can be grasped from the magnetic behavior.

The magnetic control unit may invert the polarity of the magnet to coincide with a polarity of a magnet incorporated in the other communication apparatus when the communication with the other communication apparatus is completed and the communication apparatus is a releasing side in an established connection with the other communication apparatus.

The magnetic control unit may invert the polarity of the magnet to coincide with the polarity of the magnet incorporated in the communication apparatus when it is determined that data transmission to the other communication apparatus has been completed.

The magnetic control unit may invert the polarity of the magnet to coincide with the polarity of the magnet incorporated in the other communication apparatus when it is determined that data reception from the other communication apparatus has been completed.

The magnetic control unit may control that the generation of a magnetic field from the magnet so as to have the polarity opposite to the polarity of the magnet incorporated in the other communication apparatus when a connection with the other communication apparatus is established.

The magnetic control unit may control the generation of a magnetic field from the magnet so as to have the polarity opposite to the polarity of the magnet incorporated in the other communication apparatus while data exchange is being conducted with the other communication apparatus.

The magnetic control unit may control the generation of a magnetic field from the magnet so as to have the polarity opposite to the polarity of a magnet incorporated in the other communication apparatus when a certain time has elapsed after the connection is established with the other communication apparatus.

The magnetic control unit may control the magnetic force of the magnet depending on a change in a communication rate with the other communication apparatus during communicating with the other communication apparatus. In this case, the magnetic control unit may control the magnetic force of the magnet so as to be reversely proportional to the change in the communication rate with the other communication apparatus.

The magnetic control unit may control the polarity of the magnet based on polarity determination information received from the other communication apparatus when the communication unit establishes a connection with the other communication apparatus.

According to another embodiment of the present invention, there is provided a communication system including: a first communication apparatus including a communication unit for performing communication through electric field coupling or magnetic field coupling; and a second communication apparatus including a communication unit for performing communication through electric field coupling or magnetic field coupling, wherein the communication system includes in at least either the first communication apparatus or the second communication apparatus,

at least one magnet arranged near the communication unit; and

a magnetic control unit for controlling a polarity and a magnetic force of the magnet depending on a communication status of the communication unit.

According to another embodiment of the present invention, there is provided a communication method including the steps of: having a communication unit perform communication through electric field coupling or magnetic field coupling with other communication apparatus; and controlling a polarity and a magnetic force of at least one magnet arranged near the communication unit depending on a communication status between the communication unit and the other communication apparatus.

According to another embodiment of the present invention, there is provided a computer program for causing a computer to perform the steps of: having a communication unit perform communication through electric field coupling or magnetic field coupling with other communication apparatus; and controlling the polarity and the magnetic force of at least one magnet arranged near the communication unit depending on a communication status between the communication unit and other communication apparatus.

As described above, according to the present invention, it is possible to provide a communication apparatus, communication method, communication system and computer program capable of grasping a change in a communication status through electric field coupling or magnetic field coupling from a magnetic behavior by utilizing a polarity of a magnet.

### BRIEF DESCRIPTION OF THE DRAWINGS

FIG. 1 is an explanatory diagram showing a communication system according to one embodiment of the present invention;

FIG. 2 is an explanatory diagram showing a configuration of a communication apparatus 100 and a communication apparatus 200 according to the present embodiment;

FIG. 3 is an explanatory diagram explaining a configuration of a magnetic control unit 110 according to one embodiment of the present invention;

FIG. 4A is an explanatory diagram schematically showing a relationship between an electric magnet and a current direction;

FIG. 4B is an explanatory diagram schematically showing a relationship between the electric magnet and the current direction;

FIG. 5 is an explanatory diagram showing one example of an arrangement position of the electric magnet;

FIG. 6 is an explanatory diagram showing one example of the arrangement position of the electric magnet;

FIG. 7 is a flow diagram explaining an operation of the magnetic control unit 110 according to one embodiment of the present invention; and

FIG. 8 is an explanatory diagram explaining a control of a magnetic force of an electric magnet 120 in the magnetic control unit 110 according to one embodiment of the present invention.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

FIG. 1 is an explanatory diagram showing a communication system according to one embodiment of the present invention. As shown in FIG. 1, the communication system according to the present embodiment includes a pair of devices (communication apparatus) having a communication device 10 and a portable device 20, and an information processing apparatus 12. Furthermore, the communication device 10 and the portable device 20 include an electrode plate which is referred to as electric field coupler allowing electric field coupling with each other. When both electric field couplers of the communication device 10 and the portable device 20 approach within 3 cm of each other, for example, a change in inductive electric field occurring by one electric field coupler is sensed by the other electric field coupler, so that electric field communication is achieved

between the communication device 10 and the portable device 20.

Specifically, in a pair of devices for making the above electric field communication, one of the pair functions as an initiator and the other functions as a responder. The initiator is directed for making a connection establishment request, and the responder is directed for receiving the connection establishment request from the initiator.

For example, when the portable device 20 shown in FIG. 1 functions as an initiator, and the communication device 10 functions as a responder, if the portable device 20 and the communication device 10 approach each other, the communication device 10 receives a connection establishment request transmitted from the portable device 20. Then, when the connection establishment request is received by the communication device 10, the communication device 10 and the portable device 20 perform authentication processing, and if the authentication processing ends normally, the communication device 10 and the portable device 20 are connected in a state where data communication is possible. The authentication processing includes, for example, confirmation as to whether software versions or emulation systems indicating protocol are coincided between the communication device 10 and the portable device 20.

Thereafter, the communication device 10 and the portable device 20 make data communication on a one-to-one basis. More specifically, the portable device 20 transmits arbitrary data to the communication device 10 by an electric field coupler, and the communication device 10 outputs the data received from the portable device 20 to the information processing apparatus 12. Alternatively, arbitrary data is input from the information processing apparatus 12 into the communication device 10, and the communication device 10 transmits the data input from the information processing apparatus 12 to the portable device 20 by the electric field coupler. The arbitrary data includes music data such as music, lecture or radio program, video data such as cinema, TV program, video program, photographs, documents, pictures and graphics, or games and software.

Since a radio wave emitted from an antenna attenuates in reverse proportion to the square of the distance and the intensity of the inductive electric field occurring from the electric field coupler is reversely proportional to the fourth power of the distance, the distance between a pair of devices capable of electric field communication can be advantageously restricted. In other words, there can be obtained effects that deterioration in a signal due to surrounding obstacles is less in the electric field communication and a technique for preventing hacking or securing confidential can be simplified.

A radio wave emitted from an antenna has a transverse wave component oscillating in a direction orthogonal to the wave traveling direction and a polarized wave is present therein. To the contrary, since the electric field coupler generates an inductive electric field having a longitudinal wave component oscillating in the traveling direction and having no polarized wave, if the faces of the pair of electric field couplers are opposed to each other, a signal can be conveniently received at the reception side.

According to a communication system using a high frequency and a broadband such as the UWB communication, data transmission at an extremely high speed of several hundreds Mbps can be realized in a short distance. When the UWB communication is made through electric field coupling instead of the radio wave communication, since the electric field intensity is reversely proportional to the fourth power of the distance, the electric field intensity (radio wave intensity) 3 m away from the radio wave equipment is restricted equal to or less than a predetermined level, thereby obtaining a weak radio wave requiring no radio station license and configuring the communication system at a low cost. Further, when the data communication is made through electric field coupling in an extremely short distance, it is possible to securely prevent hacking on a transmission path and to secure confidential without deterioration in signal quality due to surrounding reflecting objects. Further, the electric field intensity is restricted equal to or less than a predetermined level to enable the communication only within 3 cm, for example, thereby configuring such that two devices can hardly communicate with one device at the same time and realizing one-to-one communication in a short distance.

In the present specification, there will be described an example in which a pair of communication apparatus utilizes an electric field coupler to make short distance wireless communication (non-contact communication), but the present invention is not limited to the example. For example, a pair of communication apparatus can also make short distance wireless communication via a communication unit capable of communication through magnetic field coupling.

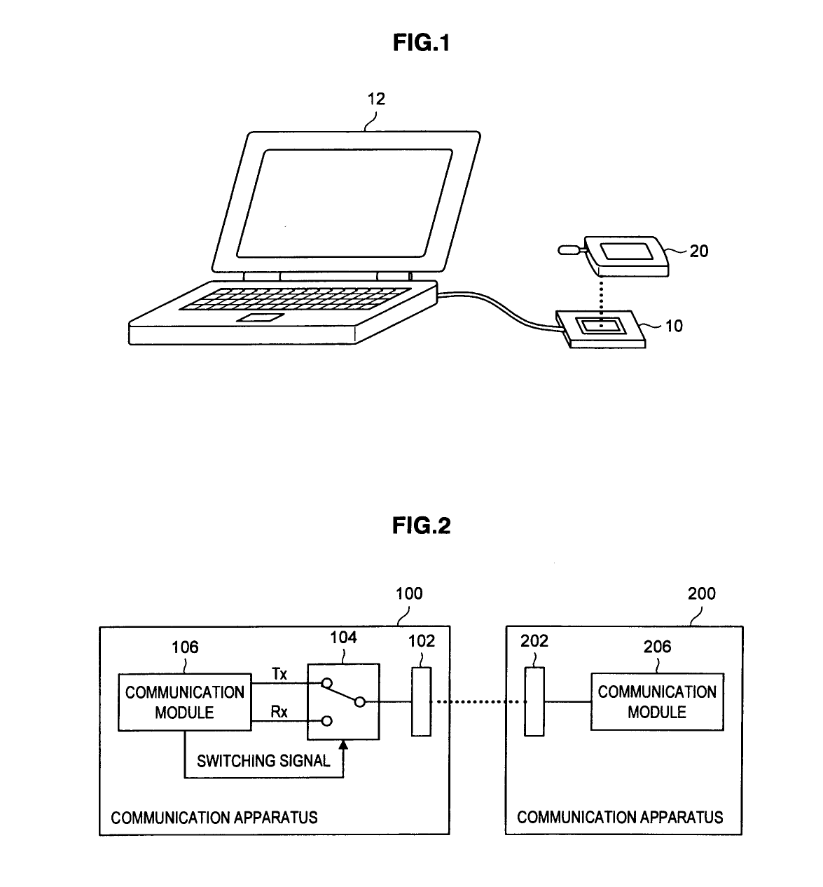

Further, the communication device 10 and the portable device 20 are merely shown as one example of the communication apparatus in FIG. 1, and thus the present invention is not limited to the example. For example, the communication apparatus may be an information processing apparatus such as PC (personal computer), home video processing device (such as DVD recorder or video cassette recorder), cell phone, PHS (personal handyphone system), portable music player, portable video processing device, PDA (personal digital assistants), home game device, portable game device or household electrical appliance. Furthermore, the communication apparatus may be a content server 30 for providing content data as shown in FIG. 2.

FIG. 2 shows a configuration of a communication apparatus 100 and a communication apparatus 200 according to the present embodiment. As shown in FIG. 2, the communication apparatus 100 according to the present embodiment includes an electric field coupler 102, a selector 104 and a communication module 106, and the communication apparatus 200 includes an electric field coupler 202 and a communication module 206.

In the communication apparatus 100 according to the present embodiment, data transmission is possible when a transmission circuit contained in the communication module 106 and the electric field coupler 102 are connected with each other by the selector 104. On the other hand, in the communication apparatus 100 according to the present embodiment, data reception is possible when a reception circuit and the electric field coupler 102 are connected with each other by the selector 104.

When the communication apparatus 100 and the communication apparatus 200 are configured in this manner, if the electric field coupler 102 and the electric field coupler 202 approach each other, the short distance wireless communication (non-contact wireless communication) through electric field coupling is enabled. The short distance wireless communication through electric field coupling is also disclosed in Japanese Patent Application Laid-Open No. 2006-60283 and Japanese Patent Application Laid-Open No. 2008-99236 and the detailed description thereof will be omitted.

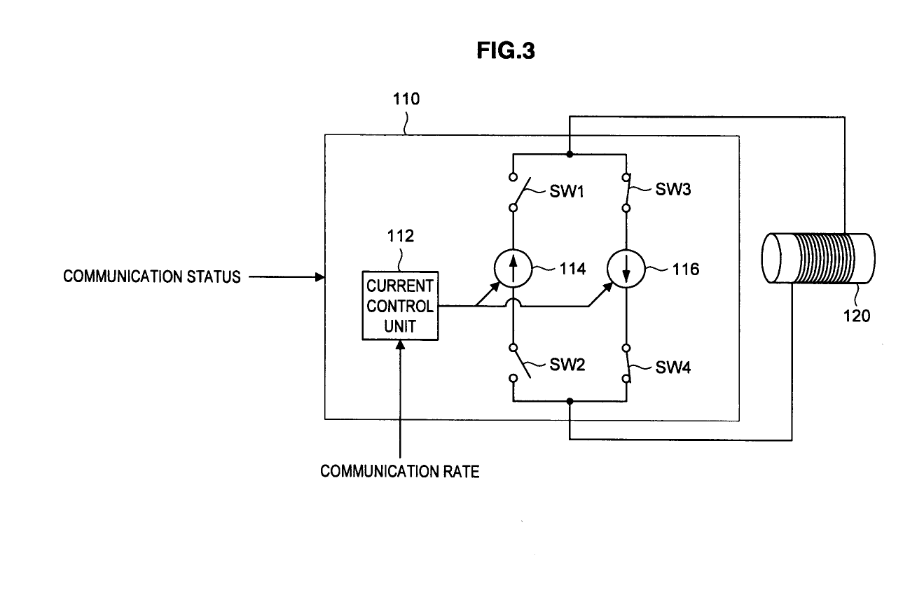

The configuration of the communication apparatus 100 and the communication apparatus 200 according to the present embodiment has been described above. Hereinafter, a configuration of a magnetic control unit incorporated in a communication apparatus according to one embodiment of the present invention will be described. FIG. 3 is an explanatory diagram showing a configuration of a magnetic control unit 110 according to one embodiment of the present invention.

The magnetic control unit 110 is incorporated inside the communication apparatus 100 (or communication apparatus 200), and may be incorporated inside the communication module 106 shown in FIG. 2, for example, or may be incorporated inside the communication apparatus 100 separately from the communication module 106. The magnetic control unit 110 controls the polarity or the magnetic force of an electric magnet 120 depending on a communication status between the communication apparatus 100 and other communication apparatus. The magnetic control unit 110 includes a current control unit 112, power supplies 114, 116, and switches SW1, SW2, SW3, SW4.

The current control unit 112 controls a magnitude of a current flowing from the power supply 114, 116 depending on the communication status between the communication apparatus 100 and other communication apparatus. In the present embodiment, the current control unit 112 controls the magnitude of the current flowing from the power supply 114, 116 depending on a communication rate (communication speed) between the communication apparatus 100 and other communication apparatus. As the communication rate between the communication apparatus 100 and other communication apparatus increases (the communication speed increases), the communication apparatus 100 and other communication apparatus are determined as closely approaching each other, and the current flowing from the power supply 114, 116 is reduced. On the other hand, as the communication rate between the communication apparatus 100 and other communication apparatus decreases (the communication speed decreases), the communication apparatus 100 and other communication apparatus are determined as being spaced, and the current flowing from the power supply 114, 116 is increased such that the communication apparatus 100 and other communication apparatus closely approach each other.

The power supplies 114, 116 flow a direct current to the electric magnet 120, respectively, to generate a magnetic field from the electric magnet 120. The current from the power supplies 114, 116 flows to the electric magnet 120 so that the magnetic field depending on the direction of current and the amount of current generates from the electric magnet 120. The direction and intensity of the magnetic field occurring from the electric magnet 120 can be changed through the control of the current control unit 112 or the switches SW1 to SW4.

The switches SW1 to SW4 control the direction of current supplied to the electric magnet 120. As shown in FIG. 3, when the switches SW1 and SW2 are connected, the current occurring from the power supply 114 is supplied to the electric magnet 120, and when the switches SW3 and SW4 are connected, the current occurring from the power supply 116 is supplied to the electric magnet 120.

The present embodiment assumes that the switches SW1 and SW2 are connected and a current occurring from the power supply 114 is supplied to the electric magnet 120 so that the electric magnet 120 generates a magnetic field by which the surface of the electric field coupler 102 is N pole. Furthermore, it is assumed that the switches SW3 and SW4 are connected and that a current occurring from the power supply 116 is supplied to the electric magnet 120 so that the electric magnet 120 generates a magnetic field by which the surface of the electric field coupler 102 is S pole.

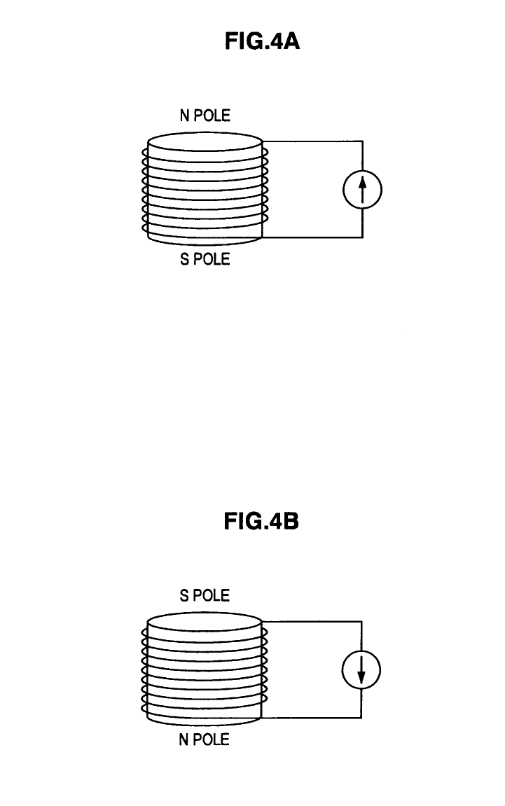

The electric magnet 120 is one example of the magnet according to the present invention, in which a current winding around an iron core flows so that a magnetic field is generated from the iron core. FIGS. 4A and 4B are explanatory diagrams schematically showing a relationship between the electric magnet and a current direction. In FIG. 4A, N pole and S pole appear as illustrated based on the corkscrew rule. In the case of FIG. 4B in which the current direction is the reverse of that of FIG. 4A, N pole and S pole appear as illustrated.

The electric magnets are provided in the two communication apparatus, respectively. In this manner, the current flow direction is switched and thus the positions of N pole and S pole in the surface (the surface the other communication apparatus approaches) of the electric field coupler are changed so that the electric magnets attract or repel each other. The polarity of the electric magnet is changed depending on a change in the communication status, thereby grasping a reduction in the communication rate or the completion of the communication from a magnetic behavior. In the following explanation, “N pole” and “S pole” designate a polarity in the surface of the electric field coupler.

For example, the electric magnets are provided in both the communication device 10 and the portable 20 shown in FIG. 1 and in both the communication apparatus 100 and the communication apparatus 200 shown in FIG. 2. The number of electric magnets provided in one communication apparatus may be one or more. Furthermore, the magnetic force generated by the electric magnet is desirably no more than a magnitude which does not affect the short distance wireless communication through electric field coupling.

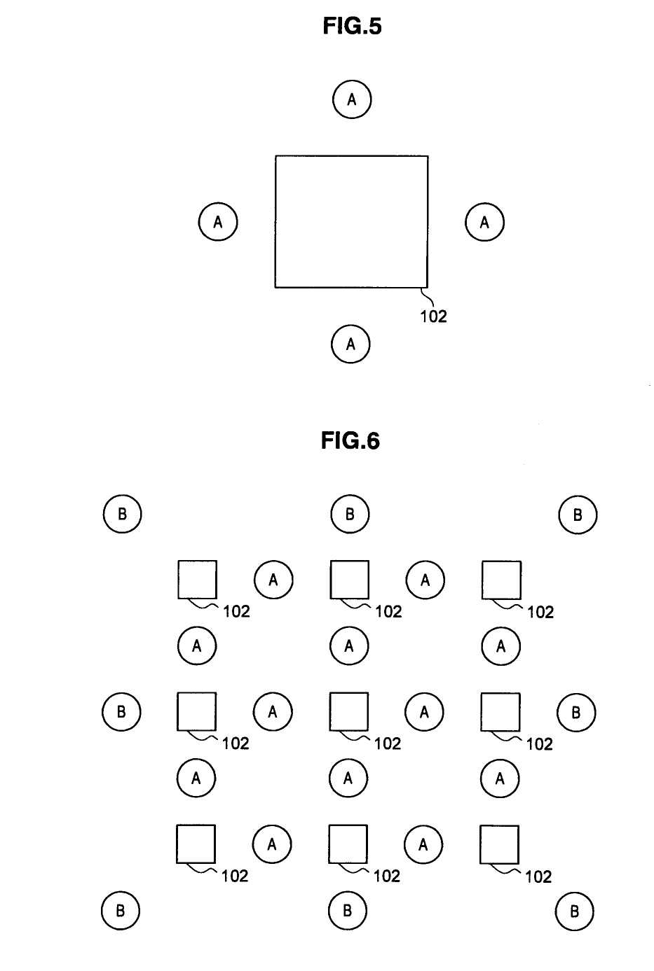

FIGS. 5 and 6 are explanatory diagrams showing one example of positional arrangement of the electric magnet. FIG. 5 shows one example in which an electric magnet is arranged near the electric field coupler 102 provided in the communication apparatus 100. FIG. 6 shows one example in which a plurality of electric field couplers 102 are provided in the communication apparatus 100 and electric magnets are provided near the respective electric field couplers 102.

Although FIGS. 5 and 6 show a case where the electric magnet is arranged near the electric field coupler 102, the electric magnet may be arranged similarly to FIGS. 5 and 6, and thus it may also be near the electric field coupler incorporated in the communication apparatus (for example, the communication apparatus 200 shown in FIG. 2) for approaching the communication apparatus 100 to achieve short distance wireless communication (In the following explanation, a case will be described in which the communication apparatus 200 approaches the communication apparatus 100 to establish short distance wireless communication through electric field coupling).

At first, one example of the positional arrangement of the electric magnet shown in FIG. 5 will be described. FIG. 5 shows a case where in which the electric magnet is arranged near each side of the electric field coupler 102 having a square shape (at position A in the Figure). Then, the electric field coupler of the communication apparatus 200 is caused to approach the electric field coupler 102 of the communication apparatus 100 such that the electric magnet of the communication apparatus 100 and the electric magnet of the communication apparatus 200 approach each other. Then, the electric magnet of the communication apparatus 100 and the electric magnet of the communication apparatus 200 repel or attract each other depending on the polarities of the respective electric magnets.

For example, while the communication apparatus 100 and the communication apparatus 200 are performing the short distance wireless communication, in order to make the electric field coupler 102 and the electric field coupler 202 closer to each other, the magnetic control unit 110 is controlled such that the electric magnet of the communication apparatus 100 and the electric magnet of the communication apparatus 200 have different polarities. Furthermore, the magnetic force of the electric magnet of the communication apparatus 100 is changed in order to make the electric field coupler 102 and the electric field coupler 202 closer to each other.

When the short distance wireless communication between the communication apparatus 100 and the communication apparatus 200 is completed, in order to make the electric field coupler 102 and the electric field coupler 202 distant from each other, the magnetic control unit 110 is controlled such that the electric magnet of the communication apparatus 100 and the electric magnet of the communication apparatus 200 have the same polarity.

One example of the positional arrangement of the electric magnet shown in FIG. 6 will now be described. FIG. 6 shows a case where the electric magnets are arranged near (at position A in the Figure) and around (at position B in the Figure) each side of the plurality of electric field couplers 102 having a square shape. Then, the electric field coupler of the communication apparatus 200 approaches any one of the electric field couplers of the communication apparatus 100 such that the electric magnet of the communication apparatus 100 and the electric magnet of the communication apparatus 200 approach each other. The electric magnet of the communication apparatus and the electric magnet of the communication apparatus 200 repel or attract each other depending on the polarities of the respective electric magnets.

For example, while the communication apparatus 100 and the communication apparatus 200 are making the short distance wireless communication, in order to bring any one of the electric field couplers 102 and the electric field coupler 202 closer to each other, the magnetic control unit 110 is controlled such that the electric magnet of the communication apparatus 100 arranged at the position A in the Figure and the electric magnet of the communication apparatus 200 have different polarities. Furthermore, in order to make the electric field coupler 102 and the electric field coupler 202 much closer to each other, the magnetic force of the electric magnet of the communication apparatus 100 is changed.

Then, when the short distance wireless communication between the communication apparatus 100 and the communication apparatus 200 is completed, in order to make the electric field coupler 102 and the electric field coupler 202 distant from each other, the magnetic control unit 110 is controlled such that the electric magnet of the communication apparatus 100 arranged at the position A in the Figure, another electric magnet of the communication apparatus 100 and the electric magnet of the communication apparatus 200 have the same polarity and the electric magnet of the communication apparatus 100 arranged at the position B in the Figure and the electric magnet of the communication apparatus 200 have different polarities.

In this manner, the polarity or magnetic force of the electric magnet is changed in the magnetic control unit 110 depending on the communication status, thereby achieving a change in the communication status from a magnetic behavior.

In order to match the positions of the electric magnets of the communication apparatus 100 and the communication apparatus 200, some marks may be denoted on the communication faces of the communication apparatus 100 and the communication apparatus 200 for positional matching.

In the present invention, the shape of the electric field coupler, the number of electric magnets and the arrangement positions of the electric magnets are not limited to the example. In the above description, when the communication apparatus 200 approaches the communication apparatus 100, the magnetic control unit 110 of the communication apparatus 100 is controlled to change the polarity or magnetic force of the electric magnet. However, the magnetic control unit may be similarly provided in the communication apparatus 200 to change the polarity or magnetic force of the electric magnet from the communication apparatus 200 side.

The configuration of the magnetic control unit 110 according to one embodiment of the present invention has been described above. Hereinafter, an operation of the magnetic control unit 110 according to one embodiment of the present invention will be described.

As described above, the magnetic control unit 110 according to one embodiment of the present invention controls the polarity or magnetic force of the electric magnet 120 depending on the communication status of the short distance wireless communication made between two communication apparatus (such as the communication apparatus 100 and the communication apparatus 200 shown in FIG. 2). Thus, during the short distance wireless communication made between the communication apparatus 100 and the communication apparatus 200, the operation of the magnetic control unit 110 according to one embodiment of the present invention is controlled based on the information exchanged between the two communication apparatus.

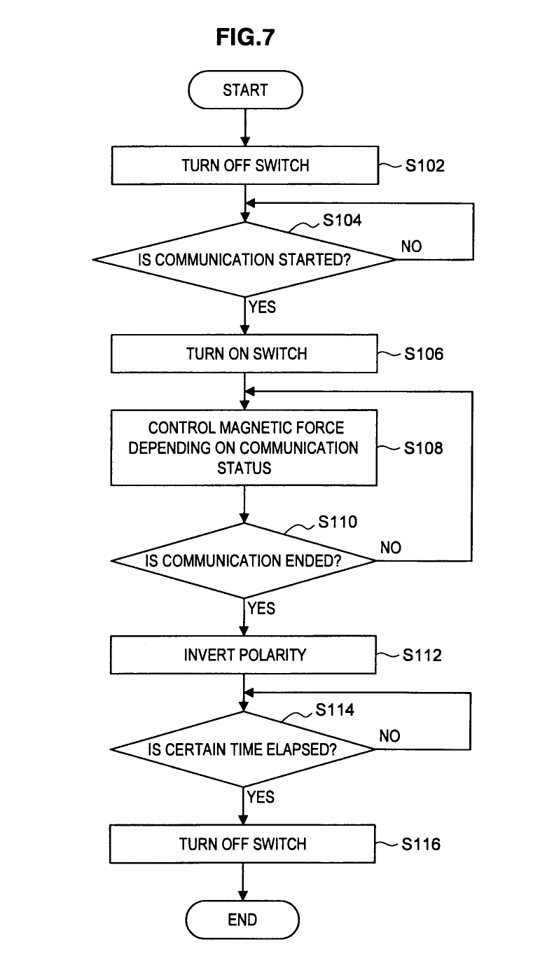

FIG. 7 is a flow diagram for explaining the operation of the magnetic control unit 110 according to one embodiment of the present invention. The operation of the magnetic control unit 110 according to one embodiment of the present invention will now be described with reference to FIG. 7. Hereinafter, a case in which the communication apparatus 200 is assumed as an initiator and the communication apparatus 100 is assumed as a responder will be described.

When the communication apparatus 100 is not performing the short distance wireless communication, all the switches SW1 to SW4 shown in FIG. 3 are set in the OFF state (step S102). Thus, since a current is not supplied from the power supplies 114, 116 to the electric magnet 120 at the time of step S102, a magnetic field is not generating from the electric magnet 120. In this state, the magnetic control unit 110 determines whether the start of the short distance wireless communication due to the approach of the communication apparatus 200 has been notified from the outside (from the communication module 106, for example) (step S104).

The start of the short distance wireless communication may be determined by whether the communication apparatus 200 has transmitted a connection establishment request to the communication apparatus 100 or whether the communication apparatus 100 has transmitted a response signal for the connection establishment request to the communication apparatus 200, for example.

When the electric field coupler 102 receives the connection establishment request transmitted from the communication apparatus 200, the communication apparatus 100 generates a response signal in the communication module 106 and transmits the generated response signal to the communication apparatus 200. The transmission of the response signal allows the connection establishment between the communication apparatus 100 and the communication apparatus 200 so that the data transmission/reception is enabled.

In this case, it may be determined that the short distance wireless communication has been started under a condition in which the connection establishment request transmitted from the communication apparatus 200 has been received in the communication module 106. Furthermore, it may be determined that the short distance wireless communication has been started under a condition in which the response signal has been transmitted from the communication apparatus 100 to the communication apparatus 200. Furthermore, it may be determined that the short distance wireless communication has been started under the condition in which a response from the communication apparatus 200 for the response signal transmitted from the communication apparatus 100 to the communication apparatus 200 has been received in the communication apparatus 100.

As a result of the determination in step S104, when it is determined that the short distance wireless communication has not been started, the processing returns to step S102, where the switches SW1 to SW4 are maintained at the OFF state. On the other hand, as a result of the determination in step S104, when it is determined that the short distance wireless communication has been started, the switches are turned ON to flow a current to the electric magnet 120 (step S106).

Which switch among the switches SW1 to SW4 is turned ON depends on the design or the setting. In the present embodiment, as described above, the electric magnet 120 is configured such that the surface of the electric field coupler 102 enters N pole when the switches SW1 and SW2 are connected and the surface of the electric field coupler 102 enters S pole when the switches SW3 and SW4 are connected. As one example, while the short distance wireless communication is being made, when the initiator side is assumed as N pole and the responder side is assumed as S pole, the switches SW3 and SW4 are connected to supply a current from the power supply 116 to the electric magnet so that the responder side (or the communication apparatus 100) can enter S pole.

When the switches are turned ON and a current flows to the electric magnet 120 in step S106, the magnetic control unit 110 controls the magnetic force of the electric magnet 120 depending on the status of the short distance wireless communication between the communication apparatus 100 and the communication apparatus 200 (step S108).

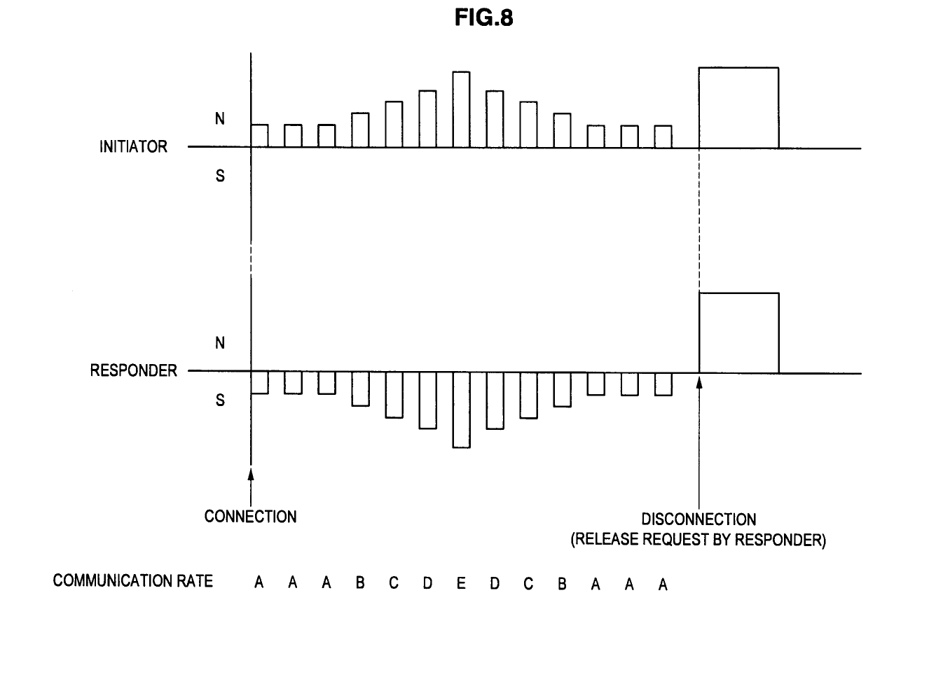

The control of the magnetic force of the electric magnet 120 in the magnetic control unit 110 will be exemplified. FIG. 8 is an explanatory diagram for explaining the control of the magnetic force of the electric magnet 120 in the magnetic control unit 110 according to one embodiment of the present invention.

FIG. 8 shows one example of a relationship between a communication rate and a magnetic force in a timeline. FIG. 8 shows that the communication rate is graded into 5 levels of A to E, and that the communication rate decreases in the order from A to E (the communication speed slows). For example, the communication speed is measured in the communication module 106 (or the communication module 206) and the magnetic control unit 110 receives the resulting measured communication rate so that the amount of current flowing from the power supplies 114, 116 can be adjusted to control the magnetic force of the electric magnet 120.

The relationship between the communication rate and the communication speed may be arbitrarily set. For example, the communication rate may be set such that the communication rate at the communication speed of 300 Mbps is assumed as A, the communication rate at half the communication speed is assumed as B, the communication rate at a quarter of the communication speed is assumed as C, and so on. Furthermore, for example, the communication rate may be set such that the communication rate at the communication speed of 300 Mbps is assumed as A, the communication rate at the communication speed of 200 Mbps is assumed as B, the communication rate at the communication speed of 100 Mbps is assumed as C, the communication rate at the communication speed of 50 Mbps is assumed as D, and so on. Of course, the relationship between the communication speed and the communication rate is not limited to the above examples and may be arbitrarily set.

The information on the communication rate may be exchanged between the communication apparatus 100 and the communication apparatus 200 constantly along with the data transmission while the connection between the communication apparatus 100 and the communication apparatus 200 is being established, or may be exchanged between the communication apparatus 100 and the communication apparatus 200 by utilizing a free time until the response signal arrives after the data transmission.

FIG. 8 shows the polarities and the intensities of the electric magnets in the initiator and the responder together. When the communication apparatus 100 and the communication apparatus 200 are being connected to each other, the polarities of the electric magnets are controlled such that the initiator and the responder have opposite polarities. Then, in the present embodiment, when the communication apparatus 100 and the communication apparatus 200 are being connected to each other, instead of continuously flowing a current to the electric magnet, the current is flowed only when the data exchange is not performed so that the magnetic field from the electric magnet does not affect the data exchange.

FIG. 8 shows how the intensity of the magnetic force of the electric magnet is changed depending on the change in the communication rate. When the communication rate is high or the communication speed is fast, it is assumed that the communication apparatus 100 and the communication apparatus 200 are close to each other. Thus, the magnetic control unit 110 controls such that the magnetic force of the electric magnet so that it is weakened.

Reasons for controlling the magnetic control unit 110 such that the magnetic force of the electric magnet is weakened when the communication speed between the communication apparatus 100 and the communication apparatus 200 is fast will be exemplified. For example, since non-contact communication can be made between the communication apparatus 100 and the communication apparatus 200, the communication between the communication apparatus 100 and the communication apparatus 200 is enabled without having the communication apparatus 100 and the communication apparatus 200 approach each other. Thus, having the communication apparatus 100 and the communication apparatus 200 being excessively close to each other when the non-contact communication is being established between the communication apparatus 100 and the communication apparatus 200 can be avoided. In this case, it is desirable that the magnetic field is weakened in order to avoid the communication apparatus 100 and the communication apparatus 200 from being excessively close to each other.

Furthermore, for example, fine scratches on the surface of the apparatus which are caused by the rubbing of the apparatus due to close contact between the communication apparatus 100 and the communication apparatus 200 when the non-contact communication is being established between the communication apparatus 100 and the communication apparatus 200 can be avoided. In this case, it is desirable that the magnetic field is weakened and that a certain distance between the apparatus is established in order to avoid the rubbing together of the apparatus due to close contact between the communication apparatus 100 and the communication apparatus 200.

Furthermore, the static magnetic field between the communication apparatus 100 and the communication apparatus 200 affects the non-contact communication is meaningless. Thus, other than the above reasons, when considerating of the possibility that the static magnetic field between the communication apparatus 100 and the communication apparatus 200 may affect non-contact communication, it is possible to control the magnetic force of the electric magnet 120 in the magnetic control unit 110 from the standpoint of a weakened static magnetic field when non-contact communication is made at a high speed.

Then, since the communication rate is low or the communication speed is slow, it is assumed that the communication apparatus 100 and the communication apparatus 200 are not close to each other, the magnetic control unit 110 controls the strengthening of the magnetic force of the electric magnet in order to make the communication apparatus 100 and the communication apparatus 200 closer to each other.

When the magnetic control unit 110 controls the magnetic force of the electric magnet 120 depending on the status of the short distance wireless communication between the communication apparatus 100 and the communication apparatus 200 in step S108, whether the magnetic control unit 110 has received a notification indicating the end of the short distance wireless communication between the communication apparatus 100 and the communication apparatus 200 is determined (step S110).

When it is determined that the magnetic control unit 110 has not received the notification indicating the end of the short distance wireless communication between the communication apparatus 100 and the communication apparatus 200 in step S110, the processing returns to step S108, where the magnetic force of the electric magnet 120 is continuously controlled. On the other hand, when the magnetic control unit 110 has received the notification indicating the end of the short distance wireless communication between the communication apparatus 100 and the communication apparatus 200, the switches are changed over to invert the polarity of the electric magnet 120 is determined (step S112).

In the present embodiment, when the communication apparatus 100 and the communication apparatus 200 are being connected to each other, the polarity of the electric magnet is controlled such that the surface of the electric field coupler 202 in the communication apparatus 200 as initiator enters N pole and the surface of the electric field coupler 102 in the communication apparatus 100 as responder enters S pole. Then, when the short distance wireless communication between the communication apparatus 100 and the communication apparatus 200 is completed, the communication apparatus 100 as responder changes the polarity of its electric magnet so that the polarities of the electric magnets in both the communication apparatus 100 and 200 enter N pole.

In the present embodiment, in order to invert the polarity of the electric magnet 120 in the communication apparatus 100, the switches SW3 and SW4 are disconnected and the switches SW1 and SW2 are connected. The switches SW3 and SW4 are disconnected and the switches SW1 and SW2 are connected so that the direction of the current flowing through the electric magnet 120 is reversed, thereby switching the polarity of the electric magnet 120 in the communication apparatus 100 to N pole.

Then, since electric magnets having the same polarity repel each other, the completion of the communication can be comprehended from the magnetic behavior. When the hand-held communication apparatus 200 is brought closer to the stationary communication apparatus 100 to achieve short distance wireless communication between the communication apparatus 100 and the communication apparatus 200, the magnetic repulsion behavior of the electric magnets having the same polarity can be felt in one's hand when the communication is completed.

In the present invention, the polarity of the electric magnet 120 may be inverted to have the same polarity as the electric magnet incorporated in the communication apparatus 200 when it is determined that the data transmission to the communication apparatus 200 has been completed, and the polarity of the electric magnet 120 may be inverted to have the same polarity as the electric magnet incorporated in the communication apparatus 200 when it is determined that the data reception from the communication apparatus 200 has been completed.

When the polarity of the electric magnet 120 is inverted in step S112, subsequently the magnetic control unit 110 determines whether a certain time has elapsed after the inversion of the polarity (step S114). As a result of the determination in step S114, when it is determined that a certain time has not elapsed from the inversion of the polarity, the polarity-inverted state is maintained. On the other hand, when it is determined that a certain time has elapsed from the inversion of the polarity, the switches are turned OFF to stop supplying a current to the electric magnet 120 (step S116).

FIG. 8 shows the inversion of the polarity of the electric magnet 120 in step S112 and the stop of the supply of the current to the electric magnet 120 after a certain time has elapsed in step S116. FIG. 8 shows that the communication apparatus 100 as responder inverts the polarity of the electric magnet 120 when the communication is completed, and the supply of the current to the electric magnet 120 is stopped after a certain time has elapsed, thereby eliminating the magnetic force.

The operation of the magnetic control unit 110 according to one embodiment of the present invention has been described above with reference to FIG. 7. In the above description, the setting of the strength of the magnetic force simply depends on the distance between the communication apparatuses. However, the present invention is not limited to the above example. For example, a setting in which the magnetic force is the weakest when the communication rate is C, the magnetic force is slightly stronger when the communication rate is B or D as compared to when the communication rate is C, and the magnetic force is the strongest when the communication rate is A or E, may be employed. Furthermore, for example, a setting in which the magnetic force is the weakest when the communication rate is B or D, and the magnetic force is the strongest when the communication rate is A, C or E, may be employed. Obviously, the present invention may be set to other patterns than the above patterns.

As described above, according to one embodiment of the present invention, when the short distance wireless communication through electric field coupling is established between two communication apparatuses, an electric magnet is provided in each communication apparatus and the magnetic forces or polarities of one of or both electric magnets are changed depending on the communication status, thereby achieving the communication status from a magnetic behavior.

A case has been described in which the short distance wireless communication is established through electric field coupling between the two communication apparatuses in the present embodiment. However, the present invention is not limited to the example, and thus is applicable in a case where communication through magnetic field coupling is established between the two communication apparatuses.

The operation of the magnetic control unit 110 described above may be performed by storing computer programs in the communication apparatus 100 (e.g. in ROM, or in EEPROM) and sequentially reading out the programs by, for example, the controller 136.

The present application contains subject matter related to that disclosed in Japanese Priority Patent Application JP 2008-164508 filed in the Japan Patent Office on Jun. 24, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

For example, in the above embodiment, the switches are turned ON to flow a current to the electric magnet 120 and to generate a magnetic field from the electric magnet 120 when the short distance wireless communication is established between the communication apparatus 100 and the communication apparatus 200. However, the present invention is not limited to the example. For example, the switches may be turned ON for flowing a current to the electric magnet 120 when a certain time has elapsed after the short distance wireless communication was started between the communication apparatus 100 and the communication apparatus 200. Furthermore, for example, after the short distance wireless communication is started between the communication apparatus 100 and the communication apparatus 200 and while the data exchange is being performed between the communication apparatus 100 and the communication apparatus 200, the switches may be turned ON for flowing a current to the electric magnet 120.

For example, a case has been described in which the initiator side is assumed as N pole and the responder side is assumed as S pole in the above embodiment. However the present invention is not limited to the example. For example, the polarity of the electric magnet may be determined based on the polarity determination information received by the electric field coupler at the time of starting the communication with the other communication apparatus is established.

For example, a case in which the communication apparatus 100 as responder and the communication apparatus 200 as initiator establish the short distance wireless communication in the present embodiment will be considered. When the communication apparatus 200 transmits a connection start request to the communication apparatus 100, the polarity determination information may be also transmitted for expressly designating the polarity of the electric magnet 120 incorporated in the communication apparatus 100. The communication apparatus 100 receiving the polarity determination information can determine the polarity of the electric magnet 120 by the magnetic control unit 110.

What is claimed is:

1. A communication apparatus comprising:
a communication unit for performing communication through electric field coupling or magnetic field coupling with other communication apparatus;
at least one magnet arranged near the communication unit; and
a magnetic control unit for controlling a polarity and a magnetic force of the magnet depending on a communication status between the communication unit and the other communication apparatus.

2. The communication apparatus according to claim 1, wherein the magnetic control unit inverts the polarity of the magnet to coincide with a polarity of a magnet incorporated in the other communication apparatus when the communication with the other communication apparatus is completed and the communication apparatus is a releasing side in an established connection with the other communication apparatus.

3. The communication apparatus according to claim 1, wherein the magnetic control unit inverts the polarity of the magnet to coincide with the polarity of the magnet incorporated in the communication apparatus when it is determined that data transmission to the other communication apparatus has been completed.

4. The communication apparatus according to claim 1, wherein the magnetic control unit inverts the polarity of the magnet to coincide with the polarity of the magnet incorporated in the other communication apparatus when it is determined that data reception from the other communication apparatus has been completed.

5. The communication apparatus according to claim 1, wherein the magnetic control unit controls the generation of a magnetic field from the magnet so as to have the polarity opposite to the polarity of the magnet incorporated in the other communication apparatus when a connection with the other communication apparatus is established.

6. The communication apparatus according to claim 1, wherein the magnetic control unit controls the generation of a magnetic field from the magnet so as to have the polarity opposite to a polarity of a magnet incorporated in the other communication apparatus while data exchange is being conducted with the other communication apparatus.

7. The communication apparatus according to claim 1, wherein the magnetic control unit controls the generation of a magnetic field from the magnet so as to have the polarity opposite to the polarity of the magnet incorporated in the other communication apparatus when a certain time has elapsed after the connection is established with the other communication apparatus.

8. The communication apparatus according to claim 1, wherein the magnetic control unit controls the magnetic force of the magnet depending on a change in a communication rate with the other communication apparatus during communication with the other communication apparatus.

9. The communication apparatus according to claim 8, wherein the magnetic control unit controls the magnetic force of the magnet so as to be reversely proportional to the change in the communication rate with the other communication apparatus.

10. The communication apparatus according to claim 1, wherein the magnetic control unit controls the polarity of the magnet based on polarity determination information received from the other communication apparatus when the communication unit establishes a connection with the other communication apparatus.

11. A communication system comprising:
a first communication apparatus including a communication unit for performing communication through electric field coupling or magnetic field coupling; and
a second communication apparatus including a communication unit for performing communication through electric field coupling or magnetic field coupling,
wherein the communication system includes in at least either the first communication apparatus or the second communication apparatus,
at least one magnet arranged near the communication unit; and
a magnetic control unit for controlling a polarity and a magnetic force of the magnet depending on a communication status of the communication unit.

12. A communication method comprising the steps of:
having a communication unit perform communication through electric field coupling or magnetic field coupling with other communication apparatus; and
controlling a polarity and a magnetic force of at least one magnet arranged near the communication unit depending on a communication status between the communication unit and the other communication apparatus.

13. A computer program for causing a computer to perform the steps of:
having a communication unit perform communication through electric field coupling or magnetic field coupling with other communication apparatus; and
controlling a polarity and a magnetic force of at least one magnet arranged near the communication unit depending on a communication status between the communication unit and the other communication apparatus.
